(19) United States
(12) Patent Application Publication
(10) Pub. No.: US 2024/0412077 A1
(43) Pub. Date: Dec. 12, 2024

(54) METHOD AND APPARATUS FOR ADVERSARIAL META-LEARNING USING ENCODER PAIR, AND COMPUTER-READABLE STORAGE MEDIUM STORING INSTRUCTIONS TO PERFORM METHOD FOR ADVERSARIAL META-LEARNING

(71) Applicant: Korea Advanced Institute of Science and Technology, Daejeon (KR)

(72) Inventors: Sung Ju HWANG, Daejeon (KR); Minseon KIM, Daejeon (KR); Hyeonjeong HA, Daejeon (KR)

(21) Appl. No.: 18/486,183

(22) Filed: Oct. 13, 2023

(30) Foreign Application Priority Data
Dec. 16, 2022 (KR) 10-2022-0177534
Jun. 9, 2023 (KR) 10-2023-0074298

(51) Int. Cl. G06N 3/0985; G06N 3/094

(52) U.S. Cl. CPC G06N 3/0985; G06N 3/094

(57) ABSTRACT

There is provided an adversarial meta-learning method. The method comprises: transforming an obtained original image for learning to generate a first transformed image and a second transformed image; generating a first vector from the first transformed image using the first encoder; generating a second vector from the second transformed image using the second encoder; generating a first noise image and a second noise image by adding noise for adversarial attack to the original image for learning using the first vector, the second vector, and the original image for learning; and repeating obtaining at least one of the first noise image or the second noise image as the original image for learning and generating the first transformed image and the second transformed image.

### TECHNICAL FIELD

The present disclosure relates to an adversarial meta-learning method and apparatus using an encoder pair.

This work was supported by Institute of Information & communications Technology Planning & Evaluation (IITP) grant funded by the Korea government (MSIT) (Project unique No.: 1711152442; Project No.: 2020-0-00153-003; Government department: Ministry of Science and ICT; R&D management Agency: Institute of Information & communications Technology Planning & Evaluation; and Research Project Title: Development of automatic detection and defense techniques for machine learning model security vulnerabilities).

### BACKGROUND

Deep learning models, despite their high performance, react sensitively to very small amounts of noise and thus sometimes fail to produce original performance, which is referred to as a vulnerability of deep learning models.

Deep learning models are particularly vulnerable to adversarial attacks, and an adversarial attack is to update a gradient using a loss function set in a direction in which prediction of a deep learning model is most incorrect. If noise is generated in this way and added to the original image, the deep learning model completely loses its performance due to the noise although the noise is not recognized by the human eye, and the prediction performance becomes 0%.

In order to create a deep learning model that is not damaged even by adversarial attacks, an adversarial learning method has been proposed. This is a learning method in which a deep learning model is trained with images generated using adversarial attacks rather than being trained using clean images during a learning process. That is, in order to cope with adversarial attacks, noise is generated in a direction in which a loss function is incorrect during learning, and then images to which the noise has been added are reused for learning to train the deep learning model to lower the loss function.

Meanwhile, meta-learning is a concept started with “meta-cognition” which allows a learning model to instantly distinguish what it knows from what it does not know, and means a learning method that self-learns with only a small amount of data and a given environment and applies learned information and algorithms to new problems to solve the problems.

However, existing meta-learning mostly focuses on meta-learning of classifiers, and thus there is a problem of low model accuracy for datasets that have not been used for learning.

### SUMMARY

An object of the present disclosure is to provide a method of training an encoder through meta-learning using an encoder pair derived from one encoder.

However, the object of the present disclosure is not limited to that mentioned above, and other objects that are not mentioned can be clearly understood by those skilled in the art from the description below.

In accordance with an aspect of the present disclosure, there is provided an adversarial meta-learning method using an encoder pair including a first encoder and a second, the apparatus comprises: transforming an obtained original image for learning to generate a first transformed image and a second transformed image; generating a first vector from the first transformed image using the first encoder; generating a second vector from the second transformed image using the second encoder; generating a first noise image and a second noise image by adding noise for adversarial attack to the original image for learning using the first vector, the second vector, and the original image for learning; and repeating obtaining at least one of the first noise image or the second noise image as the original image for learning and generating the first transformed image and the second transformed image.

The generating of the first transformed image and the second transformed image may include generating the first transformed image using a method randomly selected from among predetermined transformation methods; and generating the second transformed image using another method randomly selected from among the transformation methods.

The transformation methods may include at least two of cropping, stretching, rotation, color change, or inversion.

The first encoder and the second encoder may be derived from the same encoder and have the same structure.

The generating of the first noise image and the second noise image may include setting a first gradient of the first encoder such that a difference between the first vector and the second vector increases; generating first noise for adversarial attack using the first gradient; generating the first noise image based on the original image for learning and the first noise; setting a second gradient of the second encoder such that the difference between the first vector and the second vector increases; generating second noise for adversarial attack using the second gradient; and generating the second noise image based on the original image for learning and the second noise.

The first encoder may be trained through meta-learning by further receiving at least one of a first loss function set such that a difference between the first noise image and the original image for learning decreases or a second loss function set such that a difference between the first noise image and the second noise image decreases.

The first encoder may be used to classify a query image as one of predetermined classes when the query image is obtained

In accordance with another aspect of the present disclosure, there is provided an adversarial meta-learning apparatus, the apparatus comprises: a memory in which an adversarial meta-learning program using an encoder pair including a first encoder and a second encoder is stored; and a processor executing one or more instructions stored in the memory, wherein the instructions, when executed by the processor, cause the processor to: transform an obtained original image for learning to generate a first transformed image and a second transformed image; generate a first vector from the first transformed image using the first encoder; generate a second vector from the second transformed image using the second encoder; generate a first noise image and a second noise image by adding noise for adversarial attack to the original image for learning using the first vector, the second vector, and the original image for learning; and repeat a process of obtaining at least one of the first noise image or the second noise image as the original image for learning and generating the first transformed image and the second transformed image.

The processor may generate the first transformed image using a method randomly selected from among predetermined transformation methods and to generate the second transformed image using another method randomly selected from among the transformation methods.

The first encoder and the second encoder may be derived from the same encoder and have the same structure.

The processor may set a first gradient of the first encoder such that a difference between the first vector and the second vector increases; generate first noise for adversarial attack using the first gradient; generate the first noise image based on the original image for learning and the first noise; set a second gradient of the second encoder such that the difference between the first vector and the second vector increases; generate second noise for adversarial attack using the second gradient; and generate the second noise image based on the original image for learning and the second noise.

The first encoder may be trained through meta-learning by further receiving at least one of a first loss function set such that a difference between the first noise image and the original image for learning decreases or a second loss function set such that a difference between the first noise image and the second noise image decreases.

In accordance with another aspect of the present disclosure, there is provided a non-transitory computer-readable recording medium storing a computer program, which comprises instructions for a processor to perform an adversarial meta-learning method using an encoder pair including a first encoder and a second encoder, the method comprise: transforming an obtained original image for learning to generate a first transformed image and a second transformed image; generating a first vector from the first transformed image using the first encoder; generating a second vector from the second transformed image using the second encoder; generating a first noise image and a second noise image by adding noise for adversarial attack to the original image for learning using the first vector, the second vector, and the original image for learning; and repeating obtaining at least one of the first noise image or the second noise image as the original image for learning and generating the first transformed image and the second transformed image.

According to an embodiment, it is possible to improve classification accuracy even for a dataset that has never been used for learning by training an encoder through meta-learning using an encoder pair derived from one encoder.

### BRIEF DESCRIPTION OF THE DRAWINGS

FIG. 1 is a block diagram illustrating an adversarial meta-learning device according to an embodiment.

FIG. 2 is a block diagram conceptually illustrating functions of an adversarial meta-learning program according to an embodiment.

FIG. 3 is a block diagram illustrating a method of classifying a query image using a first encoder for which meta-learning has been completed according to an embodiment.

FIG. 4 is a flowchart illustrating a method of training the first encoder through meta-learning by the adversarial meta-learning program according to an embodiment.

### DETAILED DESCRIPTION

The advantages and features of the embodiments and the methods of accomplishing the embodiments will be clearly understood from the following description taken in conjunction with the accompanying drawings. However, embodiments are not limited to those embodiments described, as embodiments may be implemented in various forms. It should be noted that the present embodiments are provided to make a full disclosure and also to allow those skilled in the art to know the full range of the embodiments. Therefore, the embodiments are to be defined only by the scope of the appended claims.

Terms used in the present specification will be briefly described, and the present disclosure will be described in detail.

In terms used in the present disclosure, general terms currently as widely used as possible while considering functions in the present disclosure are used. However, the terms may vary according to the intention or precedent of a technician working in the field, the emergence of new technologies, and the like. In addition, in certain cases, there are terms arbitrarily selected by the applicant, and in this case, the meaning of the terms will be described in detail in the description of the corresponding invention. Therefore, the terms used in the present disclosure should be defined based on the meaning of the terms and the overall contents of the present disclosure, not just the name of the terms.

When it is described that a part in the overall specification “includes” a certain component, this means that other components may be further included instead of excluding other components unless specifically stated to the contrary.

In addition, a term such as a “unit” or a “portion” used in the specification means a software component or a hardware component such as FPGA or ASIC, and the “unit” or the “portion” performs a certain role. However, the “unit” or the “portion” is not limited to software or hardware. The “portion” or the “unit” may be configured to be in an addressable storage medium, or may be configured to reproduce one or more processors. Thus, as an example, the “unit” or the “portion” includes components (such as software components, object-oriented software components, class components, and task components), processes, functions, properties, procedures, subroutines, segments of program code, drivers, firmware, microcode, circuits, data, database, data structures, tables, arrays, and variables. The functions provided in the components and “unit” may be combined into a smaller number of components and “units” or may be further divided into additional components and “units”.

Hereinafter, the embodiment of the present disclosure will be described in detail with reference to the accompanying drawings so that those of ordinary skill in the art may easily implement the present disclosure. In the drawings, portions not related to the description are omitted in order to clearly describe the present disclosure.

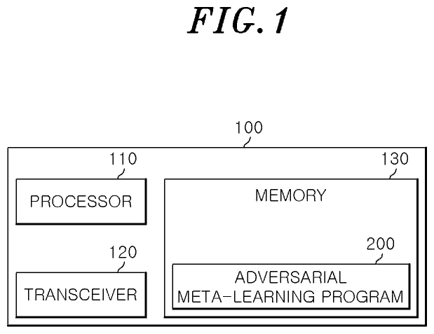

FIG. 1 is a block diagram illustrating an adversarial meta-learning apparatus according to an embodiment.

Referring to FIG. 1, the adversarial meta-learning apparatus 100 may include a processor 10, a transceiver 120, and a memory 130.

The processor 110 may control the overall operation of the adversarial meta-learning apparatus 100.

The processor 110 may receive an original image for learning used for meta-learning of a deep learning model using the transceiver 120.

Although the adversarial meta-learning apparatus 100 is described as receiving an original image for learning using the transceiver 120 in this specification, the present disclosure is not limited thereto. That is, according to the embodiment, the adversarial meta-learning apparatus 100 may include an input device (not shown) instead of or in addition to the transceiver 120, and receive an original image for learning using the input device (not shown). Further, according to the embodiment, an original image for learning may be generated in the adversarial meta-learning apparatus 100. Therefore, the adversarial meta-learning apparatus 100 may be collectively referred to as an apparatus for acquiring an original image for learning.

The memory 130 may store an adversarial meta-learning program 200 and information necessary for execution of the adversarial meta-learning program 200.

In this specification, the adversarial meta-learning program 200 may mean software including instructions programmed to train a deep learning model through meta-learning such that the deep learning model is robust against adversarial attacks.

The processor 110 may load the adversarial meta-learning program 200 and information necessary for execution of the adversarial meta-learning program 200 from the memory 130 in order to execute the adversarial meta-learning program 200.

The processor 110 may execute the adversarial meta-learning program 200 to train the deep learning model through meta-learning.

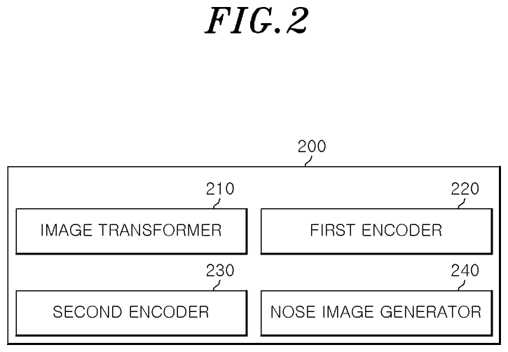

Functions and/or operation of the adversarial meta-learning program 200 will be described in detail with reference to FIG. 2.

FIG. 2 is a block diagram conceptually illustrating functions of the adversarial meta-learning program according to the embodiment.

Referring to FIG. 2, the adversarial meta-learning program 200 may include an image transformer 210, a first encoder 220, a second encoder 230, and a noise image generator 240.

The image transformer 210 may obtain an original image for learning and transform the original image for learning to generate a first transformed image and a second transformed image.

The image transformer 210 may generate the first transformed image and the second transformed image from the original image for learning using a predetermined transformation method. According to an embodiment, the transformation method may include cropping, stretching, rotation, color change, and inversion.

According to the embodiment, the image transformer 210 may generate the first transformed image and the second transformed image from the original image for learning by using different transformation methods for the original image for learning. For example, the image transformer 210 may generate the first transformed image by cutting a predetermined region from the original image for learning, and generate the second transformed image by rotating the original image for learning by 90 degrees. Alternatively, the image transformer 210 may generate the first transformed image by rotating the original image for learning 90 degrees and generate the second transformed image by rotating the original image for learning by 270 degrees, for example.

According to the embodiment, the image transformer 210 may randomly select two transformation methods from among a plurality of transformation methods to generate the first transformed image and the second transformed image.

The image transformer 210 may transmit the first transformed image to the first encoder 220 and transmit the second transformed image to the second encoder 230.

The first encoder 220 may generate a first vector by encoding the first transformed image.

The second encoder 230 may generate a second vector by encoding the second transformed image.

According to the embodiment, the first encoder 220 and the second encoder 230 may be encoders derived from the same encoder. For example, the first encoder 220 and the second encoder 230 may be derived from one encoder trained to generate a vector for an input image (or trained to classify the input image) upon receiving the image. The first encoder 220 and the second encoder 230 may have different weights, gradients, and the like because they are trained through meta-learning by additionally receiving different images although they have the same structure.

Upon receiving the first vector and the second vector, the noise image generator 240 may set a first gradient of the first encoder 220 such that a difference between the first vector and the second vector increases, generate first noise (e.g., noise for adversarial attack) using the first gradient, and generate a first noise image based on the original image for learning and the first noise.

In addition, upon receiving first vector and the second vector, the noise image generator 240 may set a second gradient of the second encoder 230 such that the difference between the first vector and the second vector increases, generate second noise (e.g., noise for adversarial attack) using the second gradient, and generate second noise image based on the original image for learning and the second noise.

According to the embodiment, the noise image generator 240 may further receive parameters of the first encoder 220 to set the first gradient and further receive parameters of the second encoder 230 to set the second gradient.

The first encoder 220 may be trained through meta-learning by further receiving at least one of a first loss function set such that a difference between the first noise image and the original image for learning decreases or a second loss function set such that a difference between the first noise image and the second noise image decreases.

In addition, the second encoder 230 may be trained through meta-learning by further receiving at least one of a third loss function set such that the difference between the second noise image and the original image for learning decreases or the second loss function.

A noise image generated by the noise image generator 240 (i.e., at least one of the first noise image or the second noise image) may be input to the image transformer 210 as an original image for learning and used to train the first encoder 220 and the second encoder 230.

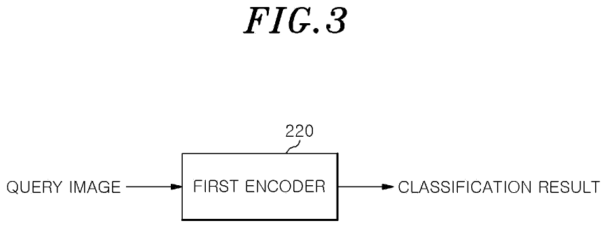

FIG. 3 is a block diagram illustrating a method of classifying a query image using the first encoder for which meta-learning has been completed according to an embodiment.

Referring to FIGS. 2 and 3, the first encoder 220 may correspond to a deep learning model for which meta-learning has been completed by the adversarial meta-learning program 200.

Upon obtaining a query image, the first encoder 220 may generate a vector for the query image or classify the query image as one of predetermined classes.

Although the first encoder 220 may be executed in the adversarial meta-learning apparatus 100 to generate a vector for a query image or classify the query image as one of predetermined classes according to the embodiment, the first encoder 220 may be executed in an apparatus other than the adversarial meta-learning apparatus 100 to generate a vector for a query image or classify the query image as one of predetermined classes.

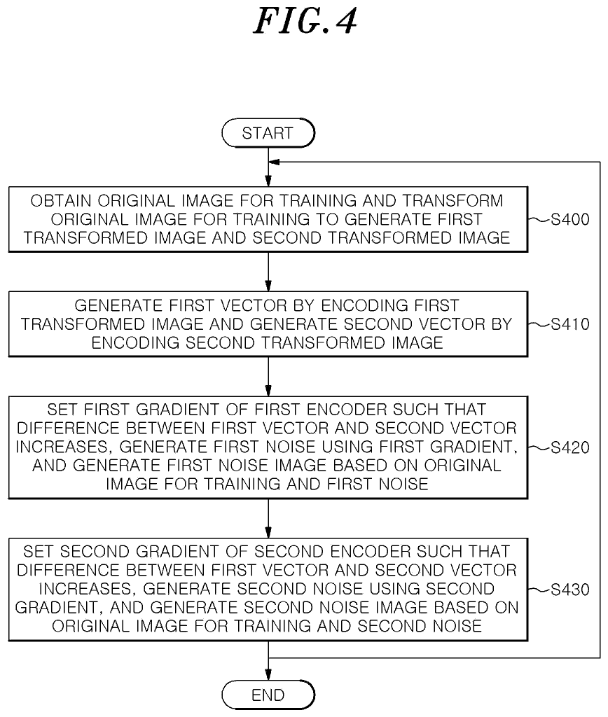

FIG. 4 is a flowchart illustrating a method of training the first encoder through meta-learning using the adversarial meta-learning program according to an embodiment.

Referring to FIGS. 2 and 4, the image transformer 210 may acquire an original image for learning and transform the original image for learning to generate a first transformed image and a second transformed image (S400).

The first encoder 220 may generate a first vector by encoding the first transformed image, and the second encoder 230 may generate a second vector by encoding the second transformed image (S410).

The noise image generator 240 may set a first gradient of the first encoder 220 such that the difference between the first vector and the second vector increases, generate first noise using the first gradient, and generate a first noise image based on the original image and the first noise (S420).

In addition, the noise image generator 240 may set a second gradient of the second encoder 230 such that the difference between the first vector and the second vector increases, generate second noise using the second gradient, and generate a second noise image based on the original image for learning and the second noise (S430).

The image transformer 210 may train the first encoder 220 and the second encoder 230 through meta-learning by repeating a process of acquiring at least one of the first noise image or the second noise image as an original image for learning and transforming the acquired original image for learning to generate the first transformed image and the second transformed image.

According to an embodiment, it is possible to improve classification accuracy even for a dataset that has never been used for learning by training an encoder through meta-learning using an encoder pair derived from one encoder.

Combinations of steps in each flowchart attached to the present disclosure may be executed by computer program instructions. Since the computer program instructions can be mounted on a processor of a general-purpose computer, a special purpose computer, or other programmable data processing equipment, the instructions executed by the processor of the computer or other programmable data processing equipment create a means for performing the functions described in each step of the flowchart. The computer program instructions can also be stored on a computer-usable or computer-readable storage medium which can be directed to a computer or other programmable data processing equipment to implement a function in a specific manner. Accordingly, the instructions stored on the computer-usable or computer-readable recording medium can also produce an article of manufacture containing an instruction means which performs the functions described in each step of the flowchart. The computer program instructions can also be mounted on a computer or other programmable data processing equipment. Accordingly, a series of operational steps are performed on a computer or other programmable data processing equipment to create a computer-executable process, and it is also possible for instructions to perform a computer or other programmable data processing equipment to provide steps for performing the functions described in each step of the flowchart.

In addition, each step may represent a module, a segment, or a portion of codes which contains one or more executable instructions for executing the specified logical function(s). It should also be noted that in some alternative embodiments, the functions mentioned in the steps may occur out of order. For example, two steps illustrated in succession may in fact be performed substantially simultaneously, or the steps may sometimes be performed in a reverse order depending on the corresponding function.

The above description is merely exemplary description of the technical scope of the present disclosure, and it will be understood by those skilled in the art that various changes and modifications can be made without departing from original characteristics of the present disclosure. Therefore, the embodiments disclosed in the present disclosure are intended to explain, not to limit, the technical scope of the present disclosure, and the technical scope of the present disclosure is not limited by the embodiments. The protection scope of the present disclosure should be interpreted based on the following claims and it should be appreciated that all technical scopes included within a range equivalent thereto are included in the protection scope of the present disclosure.

What is claimed is:

1. An adversarial meta-learning method using an encoder pair including a first encoder and a second encoder, the adversarial meta-learning method comprising:
transforming an obtained original image for learning to generate a first transformed image and a second transformed image;
generating a first vector from the first transformed image using the first encoder;
generating a second vector from the second transformed image using the second encoder;
generating a first noise image and a second noise image by adding noise for adversarial attack to the original image for learning using the first vector, the second vector, and the original image for learning; and
repeating obtaining at least one of the first noise image or the second noise image as the original image for learning and generating the first transformed image and the second transformed image.

2. The adversarial meta-learning method of claim 1, wherein the generating of the first transformed image and the second transformed image includes:
generating the first transformed image using a method randomly selected from among predetermined transformation methods; and
generating the second transformed image using another method randomly selected from among the transformation methods.

3. The adversarial meta-learning method of claim 2, wherein the transformation methods include at least two of cropping, stretching, rotation, color change, or inversion.

4. The adversarial meta-learning method of claim 1, wherein the first encoder and the second encoder are derived from the same encoder and have the same structure.

5. The adversarial meta-learning method of claim 1, wherein the generating of the first noise image and the second noise image includes:
setting a first gradient of the first encoder such that a difference between the first vector and the second vector increases;
generating first noise for adversarial attack using the first gradient;
generating the first noise image based on the original image for learning and the first noise;
setting a second gradient of the second encoder such that the difference between the first vector and the second vector increases;
generating second noise for adversarial attack using the second gradient; and
generating the second noise image based on the original image for learning and the second noise.

6. The adversarial meta-learning method of claim 5, wherein the first encoder is trained through meta-learning by further receiving at least one of a first loss function set such that a difference between the first noise image and the original image for learning decreases or a second loss function set such that a difference between the first noise image and the second noise image decreases.

7. The adversarial meta-learning method of claim 1, wherein the first encoder is used to classify a query image as one of predetermined classes when the query image is obtained.

8. An adversarial meta-learning apparatus comprising:
a memory in which an adversarial meta-learning program using an encoder pair including a first encoder and a second encoder is stored; and
a processor executing one or more instructions stored in the memory, wherein the instructions, when executed by the processor, cause the processor to:
transform an obtained original image for learning to generate a first transformed image and a second transformed image;
generate a first vector from the first transformed image using the first encoder;
generate a second vector from the second transformed image using the second encoder;
generate a first noise image and a second noise image by adding noise for adversarial attack to the original image for learning using the first vector, the second vector, and the original image for learning; and
repeat a process of obtaining at least one of the first noise image or the second noise image as the original image for learning and generating the first transformed image and the second transformed image.

9. The adversarial meta-learning apparatus of claim 8, wherein the processor is configured to generate the first transformed image using a method randomly selected from among predetermined transformation methods and to generate the second transformed image using another method randomly selected from among the transformation methods.

10. The adversarial meta-learning apparatus of claim 8, wherein the first encoder and the second encoder are derived from the same encoder and have the same structure.

11. The adversarial meta-learning apparatus of claim 8, wherein the processor is configured to:
set a first gradient of the first encoder such that a difference between the first vector and the second vector increases;
generate first noise for adversarial attack using the first gradient;
generate the first noise image based on the original image for learning and the first noise;
set a second gradient of the second encoder such that the difference between the first vector and the second vector increases;
generate second noise for adversarial attack using the second gradient; and
generate the second noise image based on the original image for learning and the second noise.

12. The adversarial meta-learning apparatus of claim 8, wherein the first encoder is trained through meta-learning by further receiving at least one of a first loss function set such that a difference between the first noise image and the original image for learning decreases or a second loss function set such that a difference between the first noise image and the second noise image decreases.

13. A non-transitory computer readable storage medium including computer executable instructions, wherein the instructions, when executed by a processor, cause the processor to perform an adversarial meta-learning method using an encoder pair including a first encoder and a second encoder, the method comprising:
transforming an obtained original image for learning to generate a first transformed image and a second transformed image;
generating a first vector from the first transformed image using the first encoder;
generating a second vector from the second transformed image using the second encoder;
generating a first noise image and a second noise image by adding noise for adversarial attack to the original image for learning using the first vector, the second vector, and the original image for learning; and
repeating obtaining at least one of the first noise image or the second noise image as the original image for learning and generating the first transformed image and the second transformed image.

14. The non-transitory computer readable storage medium of claim 13, wherein the generating of the first transformed image and the second transformed image includes:
generating the first transformed image using a method randomly selected from among predetermined transformation methods; and
generating the second transformed image using another method randomly selected from among the transformation methods.

15. The non-transitory computer readable storage medium of claim 14, wherein the transformation methods include at least two of cropping, stretching, rotation, color change, or inversion.

16. The non-transitory computer readable storage medium of claim 13, wherein the first encoder and the second encoder are derived from the same encoder and have the same structure.

17. The non-transitory computer readable storage medium of claim 13, wherein the generating of the first noise image and the second noise image includes:
setting a first gradient of the first encoder such that a difference between the first vector and the second vector increases;
generating first noise for adversarial attack using the first gradient;
generating the first noise image based on the original image for learning and the first noise;
setting a second gradient of the second encoder such that the difference between the first vector and the second vector increases;
generating second noise for adversarial attack using the second gradient; and
generating the second noise image based on the original image for learning and the second noise.

18. The non-transitory computer readable storage medium of claim 17, wherein the first encoder is trained through meta-learning by further receiving at least one of a first loss function set such that a difference between the first noise image and the original image for learning decreases or a second loss function set such that a difference between the first noise image and the second noise image decreases.

19. The non-transitory computer readable storage medium of claim 13, wherein the first encoder is used to classify a query image as one of predetermined classes when the query image is obtained.
